(19) United States
(12) Patent Application Publication
(10) Pub. No.: US 2020/0055024 A1
(43) Pub. Date: Feb. 20, 2020

(54) HYDROPROCESSING CATALYST FOR HEAVY DISTILLATE STREAMS, METHOD OF MANUFACTURE AND APPLICATION

(71) Applicant: UOP LLC, Des Plaines, IL (US)

(72) Inventors: Steven F. Zink, Westmont, IL (US); Joseph T. Kozlowski, Brookfield, IL (US)

(21) Appl. No.: 16/103,580

(22) Filed: Aug. 14, 2018

(51) Int. Cl. B01J 21/04; B01J 23/00; B01J 35/00; B01J 37/00; C10G 45/04

(52) U.S. Cl. CPC B01J 21/04; B01J 23/002; C10G 2400/04; B01J 37/0027; C10G 45/04; B01J 35/0053

(57) ABSTRACT

Catalysts are described. The catalysts comprise a dried extrudate of a mixture of γ-alumina and at least one mixed metal oxide or mixed metal hydroxide, the γ-alumina having a BET surface area of 150 m²/g to 275 m²/g. Processes of making the hydroprocessing catalysts, and hydroprocessing processes using the catalysts are also described.

### BACKGROUND

Fuel quality specifications have become more restrictive in recent years, e.g., diesel and gasoline specifications requiring lower sulfur content, lower aromatics content, lower specific gravity, and higher cetane and octane ratings, respectively. Improved hydroprocessing catalysts and process technologies are needed to meet more restrictive fuel quality specifications, and to mitigate the additional capital and/or operating expenses necessary to achieve those new fuel quality specifications.

With the need for superior hydroprocessing catalysts, therefore, there likewise remain the needs for more economical manufacturing methods which do not compromise the performance and/or strength of the finished product.

### BRIEF DESCRIPTION OF THE DRAWINGS

FIGS. 1A-C show a comparison of the specific gravity, nitrogen content, and sulfur content of the hydroprocessed feed over time.

FIGS. 2A-C show a comparison of the specific gravity, nitrogen content, and sulfur content of the hydroprocessed feed over time.

### SUMMARY AND DETAILED DESCRIPTION

The present invention relates to a novel catalyst, methods of making the catalyst, and methods of using the catalyst. The catalyst provides improved hydroprocessing activity compared to existing high activity catalysts. Relatively lower temperature or lower catalyst volume may be used to achieve at least the same extent of hydroprocessing as with existing high activity catalysts. Alternatively, the liquid product properties may be improved compared with existing high activity catalysts when operating at the same temperature.

The catalyst comprises a bulk, mixed metal oxide/hydroxide precursor that is extruded with at least a cellulose and an alumina that has been pre-calcined from boehmite to gamma alumina phase, with the gamma alumina phase having a minimum BET surface area of at least 150 m²/g. The maximum BET surface area of the gamma alumina phase is typically 275 m²/g. The prior art makes no distinction with respect to alumina type or quality. Catalysts having the specified properties are more active than those using boehmite alumina or gamma alumina with a minimum BET surface area that is, for example, less than 150 m²/g.

The catalysts provide a number of advantages over existing hydroprocessing catalysts. They offer superior hydroprocessing performance while having at least comparable manufacturability. The addition of gamma alumina also reduces the bulk density compared with catalysts not containing gamma alumina, reducing the reactor fill cost.

One aspect of the invention is a hydroprocessing catalyst. In one embodiment, the catalyst comprises a dried extrudate of a mixture of γ-alumina and at least one mixed metal oxide or mixed metal hydroxide, the γ-alumina having a BET surface area of 150 m²/g to 275 m²/g.

In some embodiments, the catalyst comprises 30 wt % or less of the γ-alumina.

In some embodiments, the catalyst further comprises at least one of: a zeolite or a silica-alumina component.

In some embodiments, the catalyst further comprises a water soluble hydroxyl-cellulose.

Another aspect of the invention is a process of making a hydroprocessing catalyst. In one embodiment, the process comprises mixing a powder comprising at least one mixed metal oxide or mixed metal hydroxide precursor, and a γ-alumina powder with water to form an extrudable dough. The dough is extruded, and the extrudates are dried at a temperature sufficient to at least remove moisture.

In some embodiments, the process further comprises pre-calcining boehmite alumina to form the γ-alumina powder.

In some embodiments, the process further comprises activating the catalyst.

In some embodiments, the process further comprises adding at least one of: a zeolitic and/or a silica-alumina Brønsted acid component to the dough, to accomplish hydrocracking reactions (hydrogenolysis of carbon-carbon bonds).

In some embodiments, the catalyst is comprised of 30 wt % or less of the γ-alumina.

In some embodiments, the process further comprises drying at least one mixed metal oxide or mixed metal hydroxide precursor at a temperature 100° C. to 300° C. to form at least one mixed metal oxide or mixed metal hydroxide.

In some embodiments, the moisture content of the at least one mixed metal oxide or mixed metal hydroxide is 5-30%.

In some embodiments, the dough is dried at a temperature of 100° C. to 250° C.

In some embodiments, the process further comprises adding a water-soluble hydroxy-cellulose.

In some embodiments, the hydroxy-cellulose is added in amount of 10 wt % or less of the dried catalyst.

Another aspect of the invention is a hydroprocessing process. In one embodiment, the process comprises passing a hydrocarbon feed and a hydrogen-rich gas to a hydroprocessing zone at hydroprocessing conditions in the presence of a hydroprocessing catalyst to produce a hydroprocessing zone effluent, the hydroprocessing catalyst comprising 10 to 90% of a catalyst comprising a dried extrudate of a mixture of γ-alumina and at least one mixed metal oxide or mixed metal hydroxide, the γ-alumina having a BET surface area of 150 m²/g to 275 m²/g.

In some embodiments, the process further comprises passing the hydroprocessing zone effluent to at least one of a hydrotreating process for the production of ultra-low sulfur diesel fuel or a hydrocracking process.

In some embodiments, the hydrocarbon feed comprises C₁₃ to C₆₀ hydrocarbons having a final boiling point of 230° C. or higher, and typically not more than 550° C.

In some embodiments, the processing conditions for the hydroprocessing process comprise at least one of: a liquid hourly space velocity of 0.25 to 10 hr⁻¹, a reactor weight average bed temperature of 245° C. to 440° C., a reactor outlet pressure of 2.4 to 19 MPa (g), and a ratio of H₂:hydrocarbon feed of 84 to 1700 Nm³/m³.

In some embodiments, the hydroprocessing catalyst further comprises a hydrotreating catalyst and/or a hydrocracking catalyst.

In some embodiments, the hydrocracking catalyst comprises at least one of a zeolite or a silica-alumina component.

In some embodiments, the catalyst comprises 20 wt % or less of the γ-alumina.

In some embodiments, the process further comprises at least one of: sensing at least one parameter of the process and generating a signal or data from the sensing; or generating and transmitting a signal; or generating and transmitting data.

The catalyst is made from at least one mixed metal oxide or mixed metal hydroxide, a water-soluble hydroxyl-cellulose, and γ-alumina powder.

The bulk, mixed metal oxide or mixed metal hydroxide precursor comprises two or more oxide and/or hydroxide precursors of Group 6, Group 10, Group 9, and Group 12 metals (current IUPAC). A suitable mixed metal oxide or mixed metal hydroxide has two to four different mixed metal oxides or mixed metal hydroxides selected from these Groups, preferably at least one Group 6 and one Group 10 mixed metal oxide or mixed metal hydroxide precursor. It is typically added in an amount of 10 to 90% of the dried finished catalyst, or 10 to 80%, or 10 to 70%, or 10 to 60%, or 10 to 50%, or 10 to 40%, or 10 to 30%, or 10 to 20%. It is synthesized according to existing processes and dried at a temperature of at least 100° C., and less than 300° C. The moisture content, as measured by % loss on ignition (LOI) is generally in the range of 5-30%, or 10-30%, or 15-30%, or 20-30%, or 25-30%.

Gamma alumina having a BET surface area of 150 m²/g to 275 m²/g is added in an amount such that it is no more than 50% of the dried finished catalyst, or 5 to 45%, or 5 to 40%, or 5 to 35%, or 5 to 30%, or 10 to 45%, or 10 to 40%, or 10 to 35%, or 10 to 30%, or 15 to 45%, or 15 to 40%, or 15 to 35%, or 15 to 30%.

A water-soluble, hydroxy-cellulose can optionally be added in an amount such that it is no more than 10% of the dried finished catalyst, or no more than 6.5%.

An optional zeolite and/or silica-alumina component may be included to provide a cracking/hydrogenolysis function. The intent of the cracking function is to preferentially crack higher-boiling distillates (e.g. heavy diesel, or VGO) to lower boiling distillates (naphtha, or kerosene/jet). Suitable zeolites include, but are not limited to, typical zeolites useful for hydrocracking, such as Y zeolite. Suitable silica-alumina components include, but are not limited to, amorphous synthetic Si/Al and naturally occurring Si/Al, such as halloysite. It is typically added in an amount of 0 to 80% of the dried finished catalyst, or 0 to 70%, or 0 to 60%, or 0 to 50%, or 0 to 40%, or 0 to 30%, or 0 to 20%.

The powders comprising the at least one mixed metal oxide or mixed metal hydroxide precursor, γ-alumina, optional hydroxy-cellulose, and optional zeolite or silica-alumina component are mixed with an appropriate volume of water to make an extrudable dough. The extrudate is then dried. The drying is typically performed at a temperature of 100° C. or more. The maximum temperature is typically 300° C., or 250° C., and the time is typically less than 12 hours, or 0.5 to 10 hours, or 0.5 to 8 hours, or 0.5 to 6 hours, or 0.5 to 3 hours.

The dried extrudate is then loaded in a hydroprocessing reactor with other catalysts intended for hydroprocessing service and activated by sulfidation as would be done by one with ordinary skill in the art. A suitable standard sulfidation method includes heating the dried extrudate in the presence of hydrogen and hydrogen sulfide or a suitable hydrogen sulfide precursor at a temperature at least 230° C. for 8 hours excluding the presence of oxygen.

The reactor loading of the catalyst of the present invention typically comprises at least 10% of the total catalyst loading, but not more than 90% of the total catalyst loading, or 10% to 80%, or 10% to 70%, or 10% to 60%, or 10% to 50%, or 10% to 40%, or 10% to 30%, or 10% to 25%, or 10% to 20%. The rest of the catalysts in the loading would be one or more additional hydrotreating or hydrocracking catalysts. It would typically be in a stacked bed arrangement of the various catalysts.

Feedstocks for a hydroprocessing process utilizing the catalyst include, but are not limited to, refinery distillates with a final boiling point of 230° C., up to 550° C. and higher (by ASTM D86, for example).

Hydrotreating is a process belonging to the family of hydroprocessing, in which a hydrogen-rich gas is contacted with a hydrocarbon stream in the presence of suitable catalysts which are primarily active for the hydrogenolysis of heteroatoms, such as sulfur, nitrogen, and metals from the hydrocarbon feedstock. In hydroprocessing, hydrocarbons with double and triple bonds may be hydrogenated. Single- and multi-ring aromatics may also be hydrogenated.

Hydroprocessing conditions typically comprise one or more of a liquid hourly space velocity of 0.25-10 h⁻¹, a reactor outlet pressure of 2.4-19 MPa(g) (24-190 bar(g)), a ratio of H₂:hydrocarbon feed of 84-1700 Nm³/m³, and a reactor weighted average bed temperature (WABT) of 245° C. to 440° C.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps. For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

### EXAMPLES

### Example 1

Catalysts comprising 83.5 wt % mixed metal oxide, 10 wt % boehmite or γ alumina, and 6.5 wt % hydroxy-cellulose were made. The mixed metal oxide was a majority component of these catalysts.

One portion of a boehmite was converted to γ alumina by oxidative heat treatment (at least 430° C. for at least 80 mins.), and the other portion of the same boehmite was not heat treated. The BET surface area of the boehmite was greater than 300 m²/g, while the BET surface area of the γ alumina was 273 m²/g.

The two catalysts of the invention were prepared by mixing the mixed metal oxide precursor powder, the boehmite powder or the γ alumina powder, the hydroxy-cellulose, and the extrudates were heat-treated for 30 minutes at a temperature less than 150° C. The mixed metal oxide powder was physically dispersed as solid particles with the other two ingredients throughout the extrudates.

A conventional, supported NiMo-type hydrotreating catalyst was used for comparison. This catalyst was prepared by dispersing an aqueous solution of the metal salts over the external and internal surface area of a support comprising γ alumina, followed by heat treatment to at least evaporate the water. The gamma alumina support is a majority component of this catalyst. It had a BET surface area of 244 m²/g.

After applying a standard method of sulfidation to each of the catalysts, the catalysts were used to hydrotreat a vacuum gas oil (VGO) from the United States Gulf Coast (USGC), as depicted with the following characteristics:

| Feed | USGC VGO |
|---|---|
| API (60/60° F.) | 20.3 |
| Specific Gravity | 0.932 |
| (60/60° F.), g/cc | |
| Hydrogen, wt % | 12.0 |
| Nitrogen, wt ppm | 1078 |
| Sulfur, wt % | 2.4 |
| IBP wt % (D-2887), ° F. | 419 |
| 5 wt %, ° F. | 656 |
| 10 wt %, ° F. | 693 |
| 30 wt %, ° F. | 776 |
| 50 wt %, ° F. | 837 |
| 70 wt %, ° F. | 903 |
| 90 wt %, ° F. | 999 |
| FBP wt %, ° F. | 1112 |

The hydrotreating conditions were:

### Temperature—371° C. (700° F.)

Pressure—13.79 MPa(g) (2000 psig)
LHSV—1.5 hr⁻¹
H₂:Feed ratio—1011 Nm³/m³ (6000 Scfb).

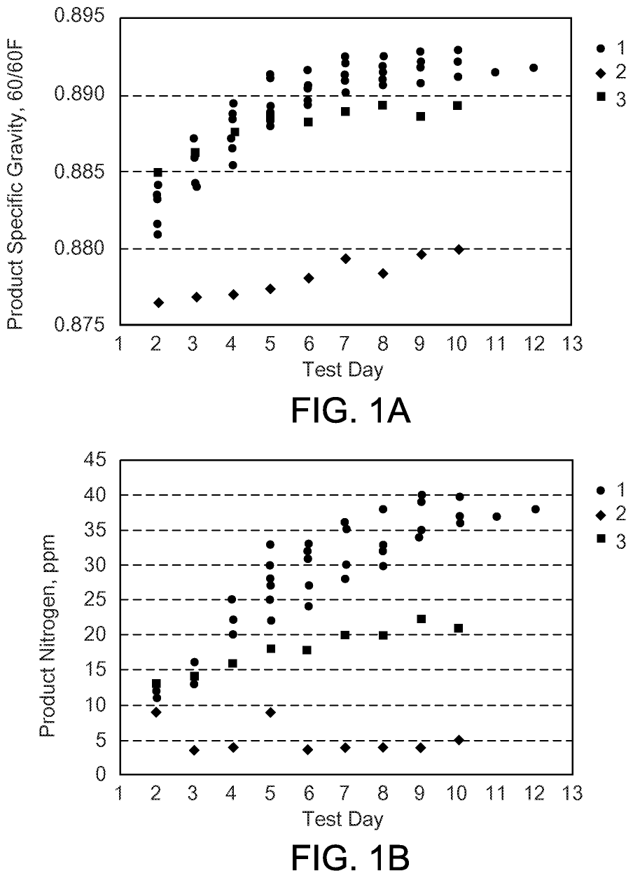

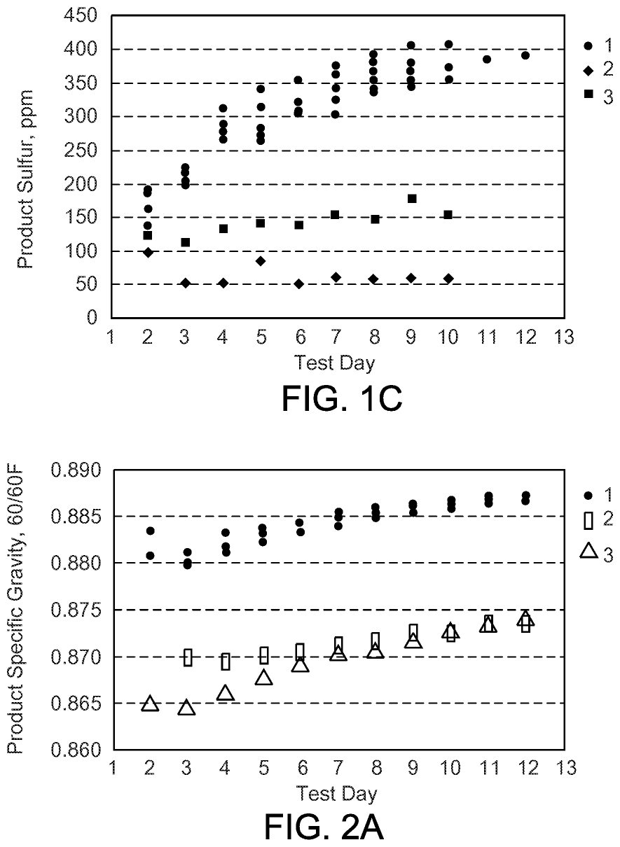

FIGS. 1A-1C compare the product specific gravity, the product nitrogen, and the product sulfur from hydrotreatment with the three catalysts described above. Lower product specific gravity and/or lower product nitrogen and/or lower product sulfur are traits of a more active catalyst. The conventional, supported NiMo-type hydrotreating catalyst is 1. The catalyst containing the 10% γ alumina is 2. The catalyst containing the 10% boehmite is 3.

The catalyst containing the γ alumina (2) delivered a hydrotreated product with the lowest specific gravity, and it maintained the lowest specific gravity over the test. In contrast, the specific gravity of both the reference catalyst (1) and the catalyst containing boehmite (3) increased over the test period. The catalyst containing the γ alumina (1) also provided the lowest levels of nitrogen and sulfur over time in the hydrotreated feed.

As FIGS. 1A-C show, the catalyst of the invention containing γ alumina (2) has the highest activity, followed by the catalyst of the invention containing boehmite (3), with the conventional, supported NiMo-type catalyst (1) having the lowest activity.

Thus, the catalyst containing the γ alumina performs better than the catalyst containing the boehmite.

### Example 2

Catalysts were prepared by mixing 83.5 wt % mixed metal oxide, 10 wt % γ alumina, and 6.5 wt % hydroxy-cellulose.

A sample of boehmite was calcined at a temperature high enough to prepare a γ alumina with a BET surface area of 250-270 m²/g (665° C. for at least 80 mins.) (2). The same sample of boehmite was calcined at a relatively higher temperature to prepare a second γ alumina with a BET surface area of 150-170 m²/g (732° C. for at least 80 mins.) (3).

The two catalysts were prepared by mixing the mixed metal oxide precursor powder, each of the two γ alumina powders (e.g., one γ alumina in one catalyst and the other γ alumina in the other catalyst), and the hydroxy-cellulose. The extrudates were heat-treated for 30 minutes at a temperature less than 150° C. The mixed metal oxide powder was physically dispersed as solid particles with the other two ingredients throughout the extrudates. The two catalysts were sulfided by a standard method.

The reference catalyst (1) was the same conventional, supported NiMo-type hydrotreating catalyst used in Example 1.

The catalysts were used to hydrotreat the same VGO feed under the same processing conditions as in Example 1.

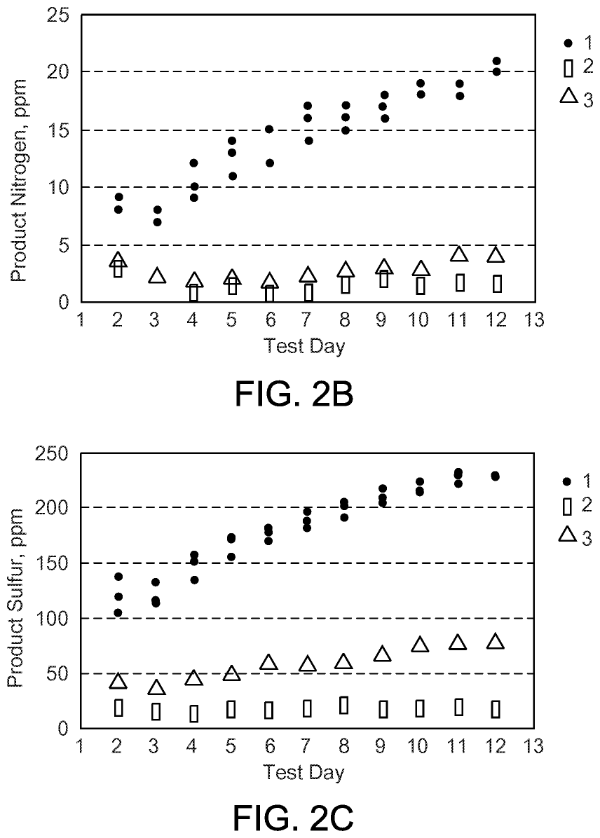

FIGS. 2A-C compare the product specific gravity, the product nitrogen, and the product sulfur from hydrotreatment with the reference catalyst and the two γ alumina catalysts. The conventional, supported NiMo-type hydrotreating catalyst is 1. The γ alumina catalyst of with the BET surface area of 250-270 m²/g is 2. The γ alumina catalyst with the BET surface area of 150-170 m²/g is 3.

The catalysts containing γ alumina (2 and 3) delivered a hydrotreated product with lower specific gravity than the reference catalyst, and the specific gravity remains lower than the reference catalyst over time. The γ alumina catalysts also showed lower levels of nitrogen and sulfur in the hydroprocessed feed over time than the reference catalyst. As FIGS. 2B and 2C show, by the end of the test the product sulfur and product nitrogen are higher with they alumina catalyst having the BET surface area of 150-170 m²/g than they alumina catalyst with the BET surface area of 250-270 m²/g.

Based on the results from Examples 1 and 2, the minimum BET surface area for they alumina is about 150 m²/g because the sulfur and nitrogen levels are still rising by the end of the test. The maximum BET surface area is about 275 m²/g because the catalyst of the invention which contains γ alumina performs better in specific gravity and product nitrogen and product sulfur levels relative to catalysts of the invention containing boehmite instead of γ alumina.

### SPECIFIC EMBODIMENTS

While the following is described in conjunction with specific embodiments, it will be understood that this description is intended to illustrate and not limit the scope of the preceding description and the appended claims.

A first embodiment of the invention is a catalyst comprising a dried extrudate of a mixture of γ-alumina and at least one mixed metal oxide or mixed metal hydroxide, the γ-alumina having a BET surface area of 150 m²/g to 275 m²/g. An embodiment of the invention is one, any or all of prior embodiments in this paragraph up through the first embodiment in this paragraph wherein the catalyst comprises 30 wt % or less of the γ-alumina. An embodiment of the invention is one, any or all of prior embodiments in this paragraph up through the first embodiment in this paragraph further comprising a water soluble hydroxy-cellulose. An embodiment of the invention is one, any or all of prior embodiments in this paragraph up through the first embodiment in this paragraph further comprising at least one of a zeolite and/or a silica-alumina component.

A second embodiment of the invention is a process of making a hydroprocessing catalyst comprising mixing a powder comprising at least one mixed metal oxide precursor or mixed metal hydroxide precursor; and a γ-alumina powder with water to form an extrudable dough; extruding the dough; and drying the dough to form the catalyst. An embodiment of the invention is one, any or all of prior embodiments in this paragraph up through the second embodiment in this paragraph further comprising pre-calcining boehmite alumina to form the γ-alumina powder. An embodiment of the invention is one, any or all of prior embodiments in this paragraph up through the second embodiment in this paragraph further comprising activating the catalyst. An embodiment of the invention is one, any or all of prior embodiments in this paragraph up through the second embodiment in this paragraph further comprising adding at least one of a zeolite or a silica-alumina component to the dough. An embodiment of the invention is one, any or all of prior embodiments in this paragraph up through the second embodiment in this paragraph wherein the catalyst comprises 30 wt % or less of the γ-alumina. An embodiment of the invention is one, any or all of prior embodiments in this paragraph up through the second embodiment in this paragraph further comprising drying at least one mixed metal oxide or mixed metal hydroxide precursor at a temperature of 100° C. to 300° C. to form the at least one mixed metal oxide or mixed metal hydroxide. An embodiment of the invention is one, any or all of prior embodiments in this paragraph up through the second embodiment in this paragraph wherein the dough is dried at a temperature of 100° C. to 250° C. An embodiment of the invention is one, any or all of prior embodiments in this paragraph up through the second embodiment in this paragraph further comprising adding a water-soluble hydroxy-cellulose. An embodiment of the invention is one, any or all of prior embodiments in this paragraph up through the second embodiment in this paragraph wherein the hydroxy-cellulose is added in amount of 10 wt % or less of the dried catalyst.

A third embodiment of the invention is a process comprising passing a hydrocarbon feed and a hydrogen-rich gas to a hydroprocessing zone at hydroprocessing conditions in the presence of a hydroprocessing catalyst to produce a hydroprocessing zone effluent, the hydroprocessing catalyst comprising 10 to 90% of a catalyst comprising a dried extrudate of a mixture of γ-alumina and at least one mixed metal oxide or mixed metal hydroxide, the γ-alumina having a BET surface area of 150 m²/g to 275 m²/g. An embodiment of the invention is one, any or all of prior embodiments in this paragraph up through the third embodiment in this paragraph further comprising passing the hydroprocessing zone effluent to at least one of a hydrotreating process producing ultra-low sulfur diesel fuel, and a hydrocracking process. An embodiment of the invention is one, any or all of prior embodiments in this paragraph up through the third embodiment in this paragraph wherein the hydrocarbon feed comprises C₁₃ to C₆₀ hydrocarbons having a final boiling point of 230° C. or higher, and typically not more than 550° C. An embodiment of the invention is one, any or all of prior embodiments in this paragraph up through the third embodiment in this paragraph wherein the processing conditions comprise at least one of a liquid hourly space velocity of 0.25 to 10 hr¹, a reactor weight average bed temperature of 245° C. to 440° C., a reactor outlet pressure of 2.4 to 19 MPa (g), and a ratio of H₂:hydrocarbon feed of 84 to 1700 Nm³/m³. An embodiment of the invention is one, any or all of prior embodiments in this paragraph up through the third embodiment in this paragraph wherein the hydroprocessing catalyst further comprises a hydrocracking catalyst. An embodiment of the invention is one, any or all of prior embodiments in this paragraph up through the third embodiment in this paragraph wherein the catalyst comprises 30 wt % or less of the γ-alumina. An embodiment of the invention is one, any or all of prior embodiments in this paragraph up through the third embodiment in this paragraph, further comprising at least one of sensing at least one parameter of the process and generating a signal or data from the sensing; or generating and transmitting a signal; or generating and transmitting data.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A catalyst comprising:
a dried extrudate of a mixture of γ-alumina and at least one mixed metal oxide or mixed metal hydroxide, the γ-alumina having a BET surface area of 150 m²/g to 275 m²/g.

2. The catalyst of claim 1 wherein the catalyst comprises 30 wt % or less of the γ-alumina.

3. The catalyst of claim 1 further comprising a water soluble hydroxy-cellulose.

4. The catalyst of claim 1 further comprising at least one of: a zeolite and/or a silica-alumina component.

5. A process of making a hydroprocessing catalyst comprising:
mixing a powder comprising at least one mixed metal oxide precursor or mixed metal hydroxide precursor; and a γ-alumina powder with water to form an extrudable dough;
extruding the dough; and
drying the dough to form the catalyst.

6. The process of claim 5 further comprising:
pre-calcining boehmite alumina to form the γ-alumina powder.

7. The process of claim 5 further comprising optionally adding at least one of: a zeolite or a silica-alumina component to the dough.

8. The process of claim 5 wherein the catalyst comprises 30 wt % or less of the γ-alumina.

9. The process of claim 5 wherein the catalyst comprises 10 to 90% of the mixed metal oxide.

10. The process of claim 5 wherein the dough is dried at a temperature of 100° C. to 175° C.

11. The process of claim 5 further comprising adding a water-soluble hydroxy-cellulose.

12. The process of claim 12 wherein the catalyst comprises 0 to 80% of at least one of a zeolite or a silica-alumina component.

13. The process of claim 5 further comprising activating the catalyst.

14. A hydroprocessing process comprising:
passing a hydrocarbon feed and a hydrogen-rich gas to a hydroprocessing zone at hydroprocessing conditions in the presence of a hydroprocessing catalyst to produce a hydroprocessing zone effluent, the hydroprocessing catalyst comprising 10 to 90% of a catalyst comprising a dried extrudate of a mixture of γ-alumina and at least one mixed metal oxide or mixed metal hydroxide, the γ-alumina having a BET surface area of 150 m²/g to 275 m²/g.

15. The process of claim 14 further comprising passing the hydroprocessing zone effluent to at least one of a hydrotreating process producing ultra-low sulfur diesel fuel, and a hydrocracking process.

16. The process of claim 14 wherein the hydrocarbon feed comprises C13 to C60 hydrocarbons having a final boiling point of 230° C. or higher, and typically not more than 550° C.

17. The process of claim 14 wherein the processing conditions comprise at least one of: a liquid hourly space velocity of 0.25 to 10 hr⁻¹, a reactor weight average bed temperature of 245° C. to 440° C., a reactor outlet pressure of 2.4 to 19 MPa (g), and a ratio of H₂:hydrocarbon feed of 84 to 1700 Nm³/m³.

18. The process of claim 14 wherein the hydroprocessing catalyst further comprises a hydrocracking catalyst.

19. The catalyst of claim 14 wherein the catalyst comprises 30 wt % or less of the γ-alumina.

20. The process of claim 14, further comprising at least one of:
sensing at least one parameter of the process and generating a signal or data from the sensing; or
generating and transmitting a signal; or
generating and transmitting data.
